(19) United States
(12) Patent Application Publication
(10) Pub. No.: US 2008/0094230 A1
(43) Pub. Date: Apr. 24, 2008

(54) USING LOCATION CAPABILITIES OF A MOBILE DEVICE TO PERMIT USERS TO AVOID POTENTIALLY HARMFUL INTERACTIONS

(75) Inventors: VON A. MOCK, BOYNTON BEACH, FL (US); MARK A. BARROS, WELLINGTON, FL (US); NONA E. GAGE, SEA RANCH LAKES, FL (US)

Correspondence Address: PATENTS ON DEMAND, P.A., 4581 WESTON ROAD, SUITE 345, WESTON, FL, 33331, US

(73) Assignee: MOTOROLA, INC., SCHAUMBURG, IL (US)

(21) Appl. No.: 11/552,077

(22) Filed: Oct. 23, 2006

(51) Int. Cl. G08B 23/00; G08B 1/08

(52) U.S. Cl. 340/573.4; 340/539.13

(57) ABSTRACT

The present invention automatically increases situational awareness relating to potential sexual predators, criminals, and/or stalkers located near a mobile device user. A location of the mobile device can be determined by device location electronics, such as a Global Positioning System (GPS). The location can be compared against at least one zone believed to be associated with a sexual predator, a criminal, and/or a stalker. Zones can be static or dynamic. A threat level associated with a zone can be computed from multiple factors, which are compared against one or more thresholds. When the threat level exceeds a thresholds, an associated threat avoidance action can be automatically initiated. One threat avoidance action is to present a warning upon a user's mobile device along with contextual information about a proximate danger.

### BACKGROUND

1. Field of the Invention

The present invention relates to mobile telecommunications and, more particularly, to using location capabilities of mobile devices to permit users to avoid potentially harmful interactions.

2. Description of the Related Art

Many people fear sexual predators, kidnappers, stalkers, and other criminal or nefarious elements endangering themselves or their loved ones. Statistics show these fears may be reasonable. For example, during 2005, crime rates, especially for violent crimes, are on the rise. It should be appreciated that robbers, sexual assailants, and so forth often prey on victims who are the most vulnerable in society; women, teens, children, and the elderly. In many cases, assailants first stalk their victims, determine their victim's behavior, and attack at a moment of particular vulnerability. These victims are usually taken by surprise.

In an effort to warn communities of nearby dangers, a number of Web sites, such as www.family.watchdog.us, are devoted to publicly listing locations and crimes of released assailants, such as registered sex offenders. These sites are often searchable and can be configured to send email notifications when new offenders move into a designated area. For these sites to be effective, users must actively monitor the sites and mark the living quarters of these published offenders. These sites must then be remembered and treated as areas of heightened danger. Few individuals are proactive enough to constantly remain aware of these areas of potential danger and to behave cautiously when near the areas. Further, even when a protector, such as a parent, discovers and discloses these areas to a potential victim, it is highly likely that the potential victim will forget or ignore the protector's warning. No known technology or solution exists that dynamically monitors a present location of a potential victim, compares this location to a set of locations containing potential assailants, and provides automatic warnings when a potential victim approaches any of these locations.

A number of geofencing solutions exist that establish geographical zones. For example, one known solution utilizes mobile telephones including Global Positioning System (GPS) components. A family member, such as a parent, can establish zones for school, work, friends' houses, malls, and the like, for a carrier of the mobile telephone with geofencing features. Notifications can be automatically sent to the parent's mobile phone when a monitored family member, such as a child, enters or leaves any of the established zones. Notifications can also be issued when a mobile phone travels over an established speed, which presumably indicates a child or teen is traveling in a vehicle at excessive speeds. Known geofencing solutions require that users manually establish boundary regions. Additionally, no known geofencing solution has been used to automatically establish zones around residences of sex offenders or other known assailants.

### SUMMARY OF THE INVENTION

The present invention utilizes location detection capabilities of mobile devices to permit users to avoid potentially harmful situations. In one embodiment, geofence boundaries can be automatically established around known dangerous areas, such as homes of known sexual offenders. When a mobile device carrier approaches one of these zones of loiters in the zone for a period, a warning can be automatically provided that includes details of a type of danger for the warned area. For example, a warning that a known sex offender lives nearby can be provided, along with the name, age, description, picture, past offenses of the offender, and other such information. The warning information can be sent to a device user and/or to a designated guardian.

The present invention can be implemented in accordance with numerous aspects consistent with material presented herein. For example, one aspect of the present invention can include a method for utilizing location abilities of a mobile device. A location of the mobile device can be determined. This determination can be made using Global Positioning System (GPS) components of the device, based upon triangulation of signals received from mobile telephony towers, and by other means. Multiple threat factors relating to a potential danger proximate to the identified location can be mathematically combined to generate a situational threat value. This value can be compared against one or more predetermined threat thresholds. When the situational threat value exceeds a threat threshold, at least one threat avoidance action can be performed. For example, a warning can be automatically presented upon the mobile device concerning the potential proximate danger.

Another aspect of the present invention can include a method for preventing harm to a mobile device user that automatically increases situational awareness of potential sexual predators, criminals, and/or stalkers near the mobile device user. The method can identify a location of the mobile device. This location can be compared against at least one zone believed to be associated with a sexual predator, a criminal, and/or a stalker. Geographical boundaries for the zone can be based upon automatically obtained information from a Web based source. These boundaries can be stationary (e.g., a home of a known sex offender) or dynamic (e.g., a zone around a potential stalker). When proximate to one of the zones, the mobile device can initiate at least one threat avoidance action that includes contextual information obtained from the Web based source. For example, a warning can be provided to a mobile device, such as “approaching a home of John Smith who has multiple convictions to raping a minor.” Additionally, an alert can be sent to a guardian, such as a parent.

Still another aspect of the present invention can include a system for warning a mobile device user of potential dangers that includes at least mobile device, a threat assessment system, and at least one Web based source. The mobile device can include location identification capabilities, such as those provided by a GPS component. The threat assessment system can calculate a situational threat value for a zone of danger when the mobile device is proximate to the zone based upon at least one factor. The threat assessment system can then compare this situational threat value against at least one threshold and can initiate at least one threat avoidance action when the situational threat value exceeds the threshold. Coordinates for at least one zone of danger and contextual information for that zone of danger can be automatically obtained from the Web based source.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact with a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a set of diagrams that illustrate how location abilities of a mobile device are able to assist a user in avoiding potentially harmful interactions in accordance with the inventive arrangements disclosed herein.

FIG. 2 is a flow chart of a method for using a mobile device to avoid potentially harmful situations in accordance with an embodiment of the inventive arrangements disclosed herein.

FIG. 3 is a schematic diagram of a system that utilizes location abilities of mobile devices to help users avoid harmful situations.

FIG. 4 illustrates one contemplated threat assessment architecture usable by the threat assessment system of FIG. 3.

### DETAILED DESCRIPTION OF THE INVENTION

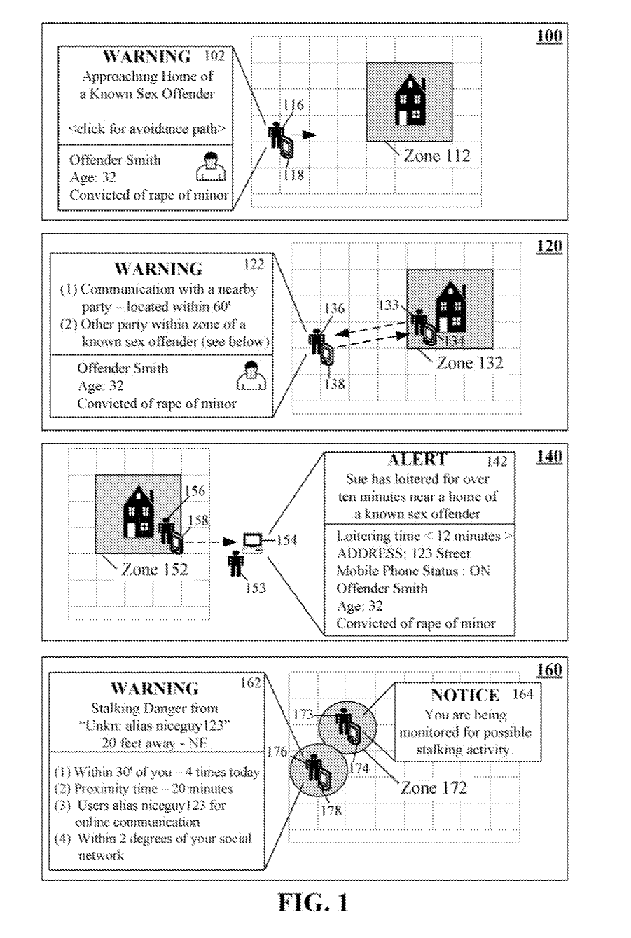

FIG. 1 is a set of diagrams 100, 120, 140, and 160 that illustrate how location abilities of a mobile device are able to assist a user in avoiding potentially harmful interactions in accordance with the inventive arrangements disclosed herein. Harmful interactions that the current solution is designed to prevent can include, but are not limited to, situations involving a known sexual predator, a stalker, or other criminal. The solution can calculate a threat probability based upon one or more factors, which can include static and dynamic factors. These factors can include, for example, a loitering factor relating to time spent proximate to a danger, a range from a danger where a danger factor can increase as a range decreases, a persistence of a danger, and the like. Any fixed region definable by geographic coordinates and any dynamic object that is locatable using location detection mechanisms can be considered a danger for purposes of the solution.

When a calculated threat probability exceeds an established threshold, one or more threat avoidance actions can be automatically taken. Different actions can be taken depending upon a threat level. These threat avoidance actions can include warning a device user of a potential threat, providing a device user with threat avoidance information, alerting a remotely located party, such as a guardian, of a potential hostile situation, and notifying a potentially dangerous individual that their activities are being monitored.

Diagram 100 includes a zone 112, which is a known zone of danger. When a mobile device 118 carrying user 116 approaches zone 112, a warning 102 can be automatically presented upon their mobile device 118. Upon receiving the warning 102, the user 116 can take suitable actions to avoid zone 112 to minimize dangers associated with the zone 112.

As shown, the warning 102 can inform user 116 that they are approaching a home of a known sex offender, identified herein for illustrative purposes only as Mr. Smith. An alternative travel path to avoid the home included in zone 112 can be provided upon request. Further, information concerning the sex offender, such as a name, age, description, past offenses, a picture, and the like can be presented upon the device 118. Armed with the information contained in warning 102, a user 116 is able to avoid compromising situations involving Mr. Smith.

In diagram 120, a user 136 can be communicatively linked with a different user 133 via mobile devices 138 and 134. A warning 122 can be presented upon device 138 to warn user 136 that the party they are communicating with is nearby. Proximity can be an indicator of a potential danger, when a communication is presumed to be anonymous and/or remote. A second factor related to the warning 122 can be that user 133 is located within a zone 132 of a known sexual offender. Information concerning the sexual offender at that residence can then be provided. It should be noted that both danger factors (proximity and communicating from a zone of danger) can be combined to generate an overall threat level that can exceed a previously designated threshold, which results in warning 122.

Diagram 140 shows that a guardian 153 for a ward 156 can be alerted 142 when the ward 156 is believed to be danger. For example, if a ward 156 loiters in a zone 152 of danger for greater than an established threshold, a message can be sent from device 158 to device 154. The alert 142 can indicate to the guardian 153 that a ward has been in a zone 152 associated with a known sex offender for greater than ten minutes. Additional contextual information, such as a running loiter time, a current position, a mobile device 158 status, and the like, can be provided.

In diagram 160, device 178 can warn 162 user 176 of a potential stalking situation involving user 173. The warning 162 can state the distance and direction of the potential threat (user 173). The warning can be based upon numerous factors, which combine to create a situational threat level significant enough to generate warning 162. For example, the device 173 can have passed within thirty feet of user 176 four times within that same day. Additionally, a current proximity time for the most recent encounter between the users 176 and 173 can be twenty minutes. The warning 162 can also note that the user of device 173 uses an online alias of “niceguy123.” This alias can be one known to user 176 from chat sites, online gaming sites, or other online forums. Further, the user 173 can be within two degrees of a social network of user 176.

In one embodiment, user 173 can be presented with a notice 164 that they are being monitored for possible stalking activity. In one implementation, user 176 can be provided an option as to whether notice 164 is to be sent. This option can permit user 176 to evaluate whether notifying user 173 that they are being monitored would be helpful in defusing a potentially dangerous situation. For example, sending notice 164 can be beneficial in a crowded situation, while it might be danger provoking in an isolated situation.

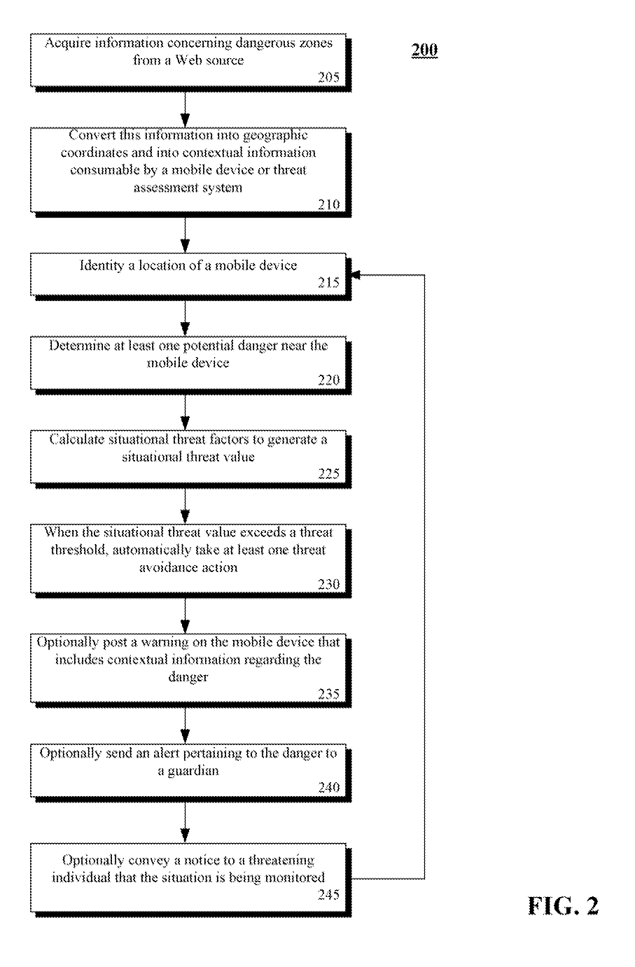

FIG. 2 is a flow chart of a method 200 for using a mobile device to avoid potentially harmful situations in accordance with an embodiment of the inventive arrangements disclosed herein. Method 200 can begin in step 205, where information concerning dangerous zones and people in an area can be acquired from a Web based source. For example, a watchdog Web site can be used to obtain information about sexual predators living or working in a particular city and relevant addresses. Additionally, crime statistics obtained from one or more Web based sources can be used to define high crime areas in the city.

In step 210, a threat assessment system can process the Web based information and can convert addresses and zones into geographic coordinates. Contextual information relating to the potential threats can also be converted into a consumable form. In one embodiment, the threat assessment system can dynamically update information on an iterative basis in ensure information currency.

In step 215, a location of a mobile device can be identified. Further, information for an area proximate to the mobile device can be automatically provided to the mobile device from the threat assessment system. In step 220, at least one potential danger near the mobile device can be determined. This danger can represent a fixed or dynamic zone of danger. In step 225, situational threat factors can be calculated to generate a situational threat value. Factors can include, but are not limited to, a distance factor, a loitering factor, a frequency of contact factor, a social network factor, and the like.

A distance factor can represent a distance between the mobile device and the potential danger, wherein a threat level relating to the distance factor can increase as the distance decreases. The loitering factor can represent an amount of time that the mobile device is proximate to the potential danger, wherein a threat level relating to the loitering factor can increase as the amount of time increases. The frequency of contact factor can represent a number of times the user of the mobile telephone has been near the potential danger, wherein a threat level relating to the frequency of contact factor can increase as the frequency increases. The social network factor can represent a distance (or number of hops) in a social network between a user of the mobile device and an individual who is part of the potential danger, where a threat level relating to the social network factor can increase as the social network distance decreases.

In step 230, at least one threat avoidance action can be automatically taken whenever a situational threat value exceeds one or more threat thresholds. Different threat thresholds can be associated with different threat avoidance actions. For example, a warning can be posted on a mobile device when the situational threat value exceeds a related threshold, which is shown in step 235. In another example, an alert can be sent to a guardian when a corresponding threshold value is exceeded, which is shown by step 240. In still another example shown in step 245, a notice can be sent to a threatening individual to place that individual on notice that they are being monitored. The method can loop from step 245 to step 215, where the mobile device location can be updated and the method can determine new situational threat values for the updated location.

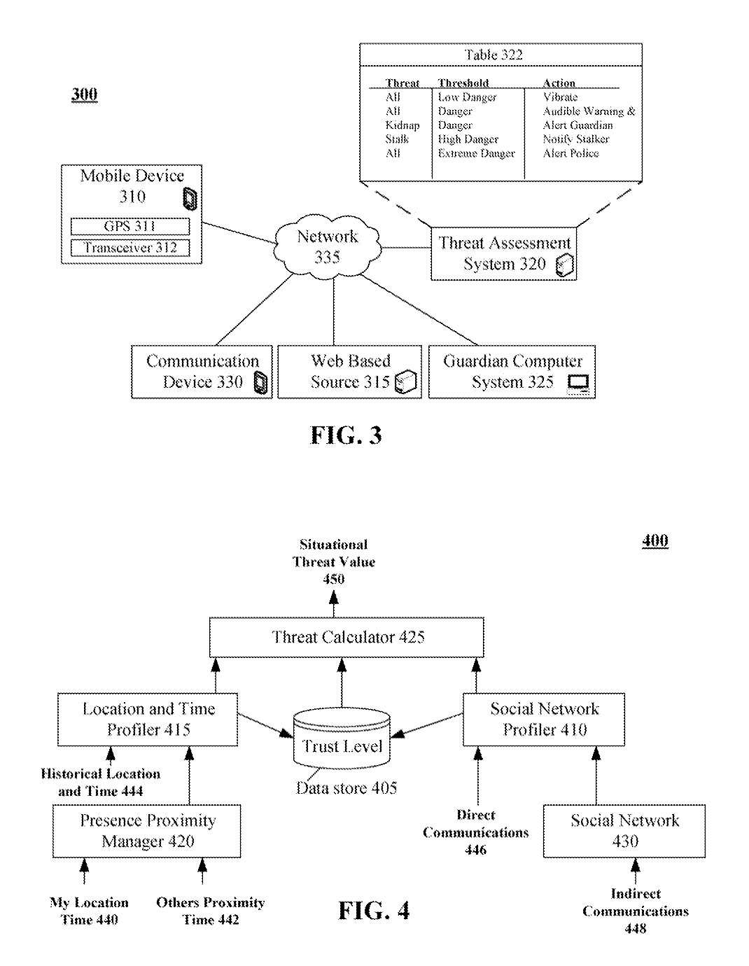

FIG. 3 is a schematic diagram of a system 300 that utilizes location abilities of mobile devices to help users avoid harmful situations. System 300 can include a mobile device 310 that includes location determination capabilities, such as those provided by GPS 311. The mobile device 310 can provide warnings to a user when a situational threat assessment value exceeds a previously established threshold. The warning can, for example, flash an icon associated with a stalker, a sexual predator, a high crime area, or other detected danger. Other sensor mechanisms, such as a vibration, audible tone, speech warning, and the like can also be used. Warnings, threshold values, threat factors, algorithms used to compute the situational threat assessment value, and other settings and options can be user configurable.

Additionally, user selectable quick options (not shown) can be presented upon the device 310 to permit a context specific response to be rapidly made. For example, when the threat warning relates to a particular individual, a quick option can include an option to alert a guardian or police of a danger. This option can be a one-click option or a panic button capable of being immediately selected in circumstances in which a user might not otherwise have time to seek external help. When a quick option is selected, contextual information, user information, and a current user location information can all be conveyed to the alert party.

The mobile device 310 can also include a short range transceiver 312, such as a BLUETOOTH transceiver, that is capable of automatically detecting proximate devices also having BLUETOOTH capabilities. For example, communication device 330 can be a BLUETOOTH equipped device carried by a potential stalker or other source of danger. Every time the communication device 330 is within BLUETOOTH range of device 310, an automatic data exchange can occur. During this exchange, mobile device 310 can be made aware of a MAC address for device 330 and of other identification information contained in device 330. When a MAC address for a device 330 repetitively comes within range of device 310, a frequency of contact value associated with device 330 can be incremented.

The mobile device 310 can include any computing device having location detection features, which is able to present warnings about proximate dangers. The location detection features can be based upon triangulation of received wireless signals from known sources, based upon GPS technologies, and any other means. The device 310 can be, but is not limited to being, a mobile phone, a two way radio, a navigation device, a personal data assistant (PDA), a wearable computer, a mobile electronic game, a media player, a notebook computer, a tablet computer, and the like.

The threat assessment calculation performed for device 310 can be performed by threat assessment system 320. The system 320 can be communicatively linked to device 310 via network 335. The threat assessment system 320 and/or portions thereof can also be implemented within device 310 (not shown) in one contemplated embodiment of the invention.

The threat assessment system 320 can determine a threat value associated with one or more different factors, which can be combined to generate a situational threat assessment value. The factors can include, but are not limited to, a distance factor, a loitering factor, a frequency of contact factor, a social network factor, and the like. Each of the factors can have different magnitudes depending on a situation. Information or input needed to compute the situational threat assessment value can be gathered from the mobile device 310, from a local data store of system 320, and/or from a Web based source 315. For example, social network information used to calculate the social network factor can be based upon information obtained from a social network Web site (source 315), such as MYSPACE.

Table 322 shows that the threat assessment system 320 can selectively initiate different actions based upon different threshold values. Different actions can also be associated with different types of threats. Thus, significant flexibility can be used in determining appropriate threat avoidance actions for different situations. For example, when a danger threshold is relatively low, the mobile device 310 can vibrate. When a danger threshold is a bit higher, the mobile device 310 can provide an audible warning and can also present one or more user selectable panic buttons upon an interface of the device 310. When the danger relates to a kidnapper, an alert of the situation can be automatically sent to a guardian (guardian computer system 325). When the danger relates to a stalker and the threshold is high, a notification can be sent to a communication device 330 associated with the potential stalker. When a user of device 310 is in an extremely dangerous situation, an alert can automatically be sent to the police. This alert can effectively be an automatic “911” emergency call.

It should be noted, that contextual danger information and/or demarcation points for zones of danger can be automatically obtained from one or more Web based sources 315. For example, a name and address for a party communicating with device 310 can be automatically obtained from a director assistance source 315. The user name and address can further be used to query other Web based sources 315 in order to obtain a photograph for the party. Past criminal offenses of a dangerous individual can also be looked-up from a Web based source 315. This information can be summarized or directly presented upon device 310, when contextually relevant.

FIG. 4 illustrates one contemplated threat assessment architecture 400 usable by the threat assessment system 320 of FIG. 3. The architecture can include a presence proximity manager 420 that processes information pertaining to a user's location and time 440 and that of others 442 near the user. The proximity manager 420 can determine proximate individuals normally associated with a location or activity, which are considered to be expected at a particular time and place. Table 1 below shows, for example, expected contacts for church, school, a mall, and a bus. These contacts can be individuals that carry devices, which can be automatically detected. For example, the user can be detected when they are located with short-range wireless communication distance (BLUETOOTH) range of a user. User presence at a location can also be obtained from a remotely located computer system.

TABLE 1
Expected Contacts by Location

| Church | School | Mall | Bus Route |
|---|---|---|---|
| Bill | Joey | Attendant A | Driver A |
| Sue | Dave | Attendant B | Passenger B |
| Sally | Betty | Friend C | Passenger C |
| *** | *** | *** | *** |
| Person N | Person M | Person O | Person P |

As shown in Table 2 for each contact, an expected duration, time and distance on average that is expected for that contact. For example, church members Bill, Sue, and Sally are expected to be proximate to a user for about two hours on Sunday from eleven A.M to two P.M.

TABLE 2
Expected Contact Durations

| Expected Person | Duration | | Time Zones | Range - avg |
|---|---|---|---|---|
| Bill | 2 | hrs | Sun 11:00 to 14:00 | 40 ft |
| Sue | 2 | hrs | Sun 11:00 to 14:00 | 50 ft |
| Sally | 2 | hrs | Sun 11:00 to 14:00 | 15 ft |
| Joey | 3 | hrs | M–F 8:00 to 13:00 | 40 ft |
| Dave | 3 | hrs | M–F 8:00 to 13:00 | 90 ft |
| Betty | 3 | hrs | M–F 8:00 to 13:00 | 50 ft |
| Attendant A | 1 | hr | Sat 10:00 to 18:00 | 10 ft |
| Attendant B | 0.25 | hr | Sat 10:00 to 18:00 | 10 ft |
| Friend C | 4 | hr | Sat 10:00 to 18:00 | 5 ft |
| Driver A | .5 | hr | M–F 6:30 to 7:30 | 10 ft |
| Passenger B | .25 | hr | M–F 6:30 to 7:30 | 10 ft |
| Passenger C | .25 | hr | M–F 6:30 to 7:30 | 10 ft |

The location and time profiler 415 can process information obtained by the manager 420 and other sources 444 and can determine when an unexpected contact appears to be consistently near a mobile telephone user. In one embodiment, the location and time profiler 415 can also record information about a typical user travel route or travel path. If a user alters this travel path, such as by taking a taxi instead of a bus, the individuals proximate to the user can be expected to change. A persistent contact that “follows” a user when that user deviates from a normal travel path can have an increased likelihood of being a stalker. It should be noted that one of the threat avoidance actions suggested by a mobile device can be to deviate from an established travel path, so that a determination can be made by profiler 415 as to whether a user is likely being followed.

The trust level data store 405 can include entries for people and locations, each having an associated trust value. Additional information, such as Web based information, available concerning those people can be used to supplement a trust value. For example, a person who is determined to be a nun from a Web based source is likely to have a higher default trust value than a previously convicted sex offender. The dynamic information processed by profiler 415 can be used to dynamically alter a trust value for a person. In one embodiment, the trust values of data store 405 can be constrained to specific times and contexts. For example, a school administrator could have a relatively high trust value around a school during school hours, but a different trust value if found in a video arcade on a weekend.

Another component of architecture 400 is a social network profiler 410. This profiler 410 can process direct communications 446, such as email, telephone calls, IM messages, interactive gaming, and other direct communications between a device user and others. In one embodiment, a social network 430 can also be monitored for indirect communications 448, which are processed by profiler 410. Many social networking sites, such as MYSPACE, TAGWORLD, ECONNECTED, and the like record social networking interactions and even provide a visual representation of a social space. A strength of an indirect contact can be based upon a number of degrees of separation or hops in the social network between a device user and others. Information from profiler 410 can be used to dynamically update trust level values of data store 405.

The threat calculator 425 can combine information from data store 405, location and time profiler 415, and social network profiler 410 to determine a situational threat value 450. It should be appreciated that a combinative effect from profiler 410 and 415 processed information can provide realistic estimates of stalking activity. For example, a communicator can engage in presumably anonymous social interactions via a Web source. Profiler 415 can indicate that a social contact is physically near the communicator, which can be an indicator of stalking activity.

The present invention may be realized in hardware, software, or a combination of hardware and software. The present invention may be realized in a centralized fashion in one computer system or in a distributed fashion where different elements are spread across several interconnected computer systems. Any kind of computer system of other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for utilizing location abilities of a mobile device comprising:
identifying a location of a mobile device;
mathematically combining a plurality of threat factors relating to a potential danger proximate to the identified location;
comparing the combined threat factors against a predetermined threat threshold; and
when the combined threat factors exceed the threat threshold, performing at least one threat avoidance action, wherein said at least one threat avoidance action comprises automatically presenting a warning upon the mobile device about the potential proximate danger.

2. The method of claim 1, wherein the notifying step further comprises:
presenting contextual information pertaining to the potential danger upon the mobile device, wherein said contextual information is automatically obtained from a Web based source.

3. The method of claim 2, wherein the potential danger is associated with a person, wherein said contextual information includes a picture of said person.

4. The method of claim 1, wherein the potential danger relates to a danger from a person who is believed to be at least one of a sexual predator, a criminal, and a stalker, and wherein a picture of the person is automatically presented upon the mobile device along with details pertaining to the potential danger.

5. The method of claim 1, wherein the potential danger relates to a fixed geographic zone, wherein coordinates for the zone are automatically obtained from a Web based source along with details pertaining to why the zone is believed to be dangerous, and wherein the zone is at least one of a residence and business location of a person who has a history of being at least one of a sexual predator and a criminal, wherein said warning includes said details.

6. The method of claim 1, wherein the potential danger is mobile, wherein location based information of the mobile danger is ascertained by determining a position of a second mobile device that is associated with the potential danger.

7. The method of claim 6, wherein the second mobile device comprises a wireless transceiver that dynamically and automatically exchanges digital content with a corresponding wireless transceiver of the mobile device, wherein a relative proximity between the devices is determined based upon a communication range of the wireless transceivers and upon content contained within communications that are exchanged between the devices.

8. The method of claim 1, wherein at least one threat avoidance action further comprises automatically alerting a remotely located guardian of the potential danger.

9. The method of claim 1, further comprising:
detecting a communication device of an individual who is part of the potential danger, wherein said at least one threat avoidance action further comprises notifying the detected communication device that the individual has been identified as a potential threat to another and is currently being monitored.

10. The method of claim 1, wherein one of the threat factors is a loitering factor representing an amount of time that the mobile device is proximate to the potential danger, wherein a threat level relating to the loitering factor increases as the amount of time increases.

11. The method of claim 1, wherein one of the threat factors is a distance factor representing a distance between the mobile device and the potential danger, wherein a threat level relating to the distance factor increases as the distance decreases.

12. The method of claim 1, wherein one of the threat factors is a frequency of contact between the potential danger and the mobile device, wherein a threat level relating to the frequency of contact factor increases as the frequency increases.

13. The method of claim 1, wherein one of the threat factors is a social network factor representing a distance in a social network between a user of the mobile device and an individual who is part of the potential danger, wherein a threat level relating to the social network factor increases as the distance decreases.

14. The method of claim 1, wherein the plurality of factors comprises at least two factors selected from a group of factors consisting of a loitering factor, a distance factor, a frequency of contact factor, and a social network factor.

15. The method of claim 14, wherein the plurality of factors comprises at least three factors selected from the group.

16. The method of claim 1, wherein said steps of claim 1 are steps performed by at least one machine in accordance with at least one computer program stored within a machine readable memory, said computer program having a plurality of code sections that are executable by the at least one machine.

17. A method for preventing harm to a mobile device user that automatically increases situational awareness of potential dangers proximate to the user relating to at least one of sexual predators, criminals, and stalkers, said method comprising:
identifying a location of a mobile device;
comparing the identified location against at least one zone known to be associated with at least one of a sexual predator, a criminal, and a stalker, wherein geographical boundaries for the zone are based upon automatically obtained information from a Web based source; and
when proximate to one of the zones, the mobile device automatically initiating at least one threat avoidance action that includes contextual information about a potential danger associated with the zone, wherein said contextual information is automatically obtained at least in part from the Web based source, wherein the at least one threat avoidance action is selected from a group of actions consisting of an action that automatically presents a warning upon the mobile device about the potential danger, an action that alerts a remotely located guardian of the potential danger via an electronic message, and an action that notifies an individual associated with the zone that possesses a communication device that the individual has been identified as a potential threat to another and is currently being monitored.

18. The method of claim 17, further comprising:
initiating the at least one threat avoidance action only when a calculated threat level exceeds a previously established threat threshold, wherein the threat level is calculated based upon at least one of a loitering factor and a distance factor, wherein the loitering factor represents an amount of time that the mobile device is proximate to the zone, wherein the threat level relating to the loitering factor increases as the amount of time increases, and wherein the distance factor represents a distance between the mobile device and the zone, wherein the threat level relating to the distance factor increases as the distance decreases.

19. A system for warning a mobile device user of potential dangers comprising:
at least one mobile device having location identification capabilities;
a threat assessment system configured to calculate a situational threat value for a zone of danger when the mobile device is proximate to the zone based upon at least one factor, to compare this situational threat value against at least one threshold, and to initiate at least one threat avoidance action when the situational threat value exceeds the at least one threshold; and
at least one Web based source from which at least one zone of danger and contextual information for that zone of danger are automatically obtained.

20. The system of claim 19, wherein said at least one threat factor includes at least one of a loitering factor and a distance factor, wherein the loitering factor represents an amount of time that the mobile device is proximate to the zone, wherein a threat level relating to the loitering factor increases as the amount of time increases, and wherein the distance factor represents a distance between the mobile device and the zone, wherein a threat level relating to the distance factor increases as the distance decreases.
